(19) United States
(12) Patent Application Publication
(10) Pub. No.: US 2026/0240238 A1
(43) Pub. Date: Aug. 20, 2026

(54) AEROSOL GENERATION DEVICE

(71) Applicant: Japan Tobacco Inc., Tokyo (JP)

(72) Inventors: Takahiro SAKAMOTO, Tokyo (JP); Kazutoshi SERITA, Tokyo (JP); Hiroshi HODONO, Tokyo (JP); Hirofumi MATSUMOTO, Tokyo (JP); Takafumi IZUMIYA, Tokyo (JP); Yusuke IKAI, Tokyo (JP)

(73) Assignee: Japan Tobacco Inc., Tokyo (JP)

(21) Appl. No.: 19/159,340

(22) PCT Filed: Mar. 3, 2023
(86) PCT No.: PCT/JP2023/008057

§ 371 Date: Aug. 25, 2025

(51) Int. Cl. A24F 40/46; A24F 40/20

(52) U.S. Cl. CPC A24F 40/46; A24F 40/20

(57) ABSTRACT

27 This aerosol generation device comprises: a receptacle capable of accommodating at least a portion of an aerosol-generating article comprising an aerosol source; an oscillator that oscillates an electromagnetic wave; a first loop antenna that supplies, to the receptacle, the electromagnetic wave oscillated by the oscillator; and a controller that controls the oscillator.

### TECHNICAL FIELD

The present invention relates to an aerosol-generating device.

### BACKGROUND ART

Recent years have seen a focus on heating methods for aerosol-generating devices such as heated tobacco, in which an aerosol-generating article (for instance a capsule or stick) containing an aerosol source is heated by microwave irradiation (e.g., see PTL 1).

### CITATION LIST

### Patent Literature

PTL 1: WO 2021/013477 A1

### SUMMARY OF INVENTION

### Technical Problem

Here, it is not always possible to suitably irradiate an aerosol-generating article with electromagnetic waves, depending on the configuration of the aerosol-generating device.

The objective of the present invention therefore lies in providing technology enabling an aerosol-generating article to be suitably irradiated with electromagnetic waves.

### Solution to Problem

In order to achieve the objective above, an aerosol-generating device according to an embodiment of the present invention is characterized by comprising:
an accommodating portion capable of accommodating at least a portion of an aerosol-generating article containing an aerosol source;
an oscillation unit for oscillating electromagnetic waves;
a first loop antenna for supplying the electromagnetic waves oscillated by the oscillation unit to the accommodating portion; and
a control unit for controlling the oscillation unit.

### Advantageous Effects of Invention

The present invention makes it possible to provide technology enabling an aerosol-generating article to be suitably irradiated with electromagnetic waves.

Other features and advantages of the present invention will be become clearer through the following description given with reference to the appended drawings. It should be noted that identical or similar components are assigned the same reference numbers in the appended drawings.

### BRIEF DESCRIPTION OF DRAWINGS

The appended drawings are included in and constitute part of the specification, illustrate embodiments of the present invention, and are used together with the descriptions to explain the principles of the present invention.

FIG. 1 shows a hardware configuration example of an aerosol-generating device.

FIG. 2 shows the structure of an accommodating portion.

FIG. 3 shows Variant Example 1 of a transmission antenna and a reception antenna.

FIG. 4 shows Variant Example 2 of a transmission antenna and a reception antenna.

FIG. 5 shows Variant Example 3 of a transmission antenna and a reception antenna.

FIG. 6 shows Variant Example 4 of a transmission antenna and a reception antenna.

FIG. 7 shows Variant Example 5 of a transmission antenna and a reception antenna.

FIG. 8 shows Variant Example 6 of a transmission antenna and a reception antenna.

FIG. 9 shows Variant Example 7 of a transmission antenna and a reception antenna.

### DESCRIPTION OF EMBODIMENTS

Embodiments will be described in detail below with reference to the appended drawings. It should be noted that the following embodiments do not limit the invention according to the claims, and not all combinations of features described in the embodiments are essential to the invention. Furthermore, two or more of the plurality of features described in the embodiments may be combined in any way. Furthermore, identical or similar components are assigned the same reference numbers and descriptions thereof will not be repeated.

### Hardware Configuration of Aerosol-Generating Device

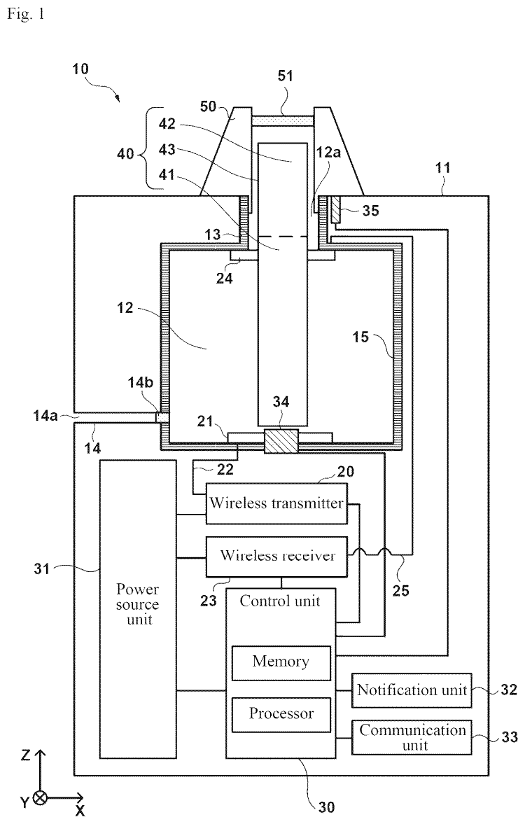

An aerosol-generating device 10 according to an embodiment of the present invention will be described with reference to FIG. 1. FIG. 1 is a schematic diagram showing a configuration example of the aerosol-generating device 10 according to this embodiment. FIG. 1 shows the aerosol-generating device 10 after an aerosol-generating article 40 and a mouthpiece 50 have been attached thereto. The mouthpiece 50 is detachable from the aerosol-generating device 10. FIG. 1 shows directions in an XYZ coordinate system where a direction of insertion of a tobacco stick 40 into the aerosol-generating device 10 is the-Z direction.

The aerosol-generating device 10 is configured to heat the aerosol-generating article 40 in response to an operation requesting atomization of an aerosol source (also referred to as an atomization request), such as a user inhalation action, and to provide the user with a vapor containing an aerosol or a vapor containing an aerosol and a flavor substance. The aerosol-generating device 10 may be referred to as an inhaler (atomizer), and the aerosol-generating device 10 may be designated as the “inhaler 10” in the following description.

The aerosol-generating article 40 is an article containing an aerosol source which generates an aerosol by means of heating, and at least a portion of the aerosol-generating article is detachably fitted in the inhaler 10 (fitted in such a way as to be capable of insertion/withdrawal). The aerosol-generating article 40 may also contain, in addition to the aerosol source, a flavor source for generating a flavor substance by means of heating. In this embodiment, the aerosol-generating article 40 is configured as a tobacco stick in the form of a substantially cylindrical rod. The aerosol-generating article 40 may be referred to as a “tobacco stick 40” below.

The tobacco stick 40 may comprise, for example: a tobacco filling portion 41, a mouthpiece portion 42, and a tipping paper 43 that integrally links the components together. The tobacco filling portion 41 comprises a tobacco filling material comprising the aerosol source and the flavor source. The mouthpiece portion 42 is linked coaxially to the tobacco filling portion 41 by being wrapped together with the tobacco filling portion 41 by the tipping paper 43. Note that a filter for stopping the tobacco filling material from falling out may also be provided at an end portion of the aerosol-generating article 40 upstream of the tobacco filling portion 41.

The tobacco filling material comprises, as the flavor source, tobacco leaves or tobacco leaf extract, or processed articles thereof, for example. In this embodiment, the tobacco filling material is configured to contain shredded tobacco. There is no particular limitation as to the material of the shredded tobacco contained in the tobacco filling material, and well-known materials such as lamina and midrib can be used. Furthermore, ground tobacco may be formed by grinding dried tobacco leaves to an average particle size of 20 μm-200 μm, then homogenized and processed into a sheet (also referred to below simply as a “homogenized sheet”) which is shredded. In another example, the tobacco filling material may comprise extruded or tableted tobacco leaves. In addition, a tobacco rod may be filled with a material obtained by shredding, in the longitudinal direction of the tobacco rod and substantially horizontally, a homogenized sheet having a length similar to that of the tobacco rod in the longitudinal direction, forming what is known as a “strand-type” filling material. Furthermore, the width of the shredded tobacco is preferably 0.5 mm-2.0 mm in order to fill the tobacco filling portion 41. Furthermore, there is no particular restriction on the content of dried tobacco leaves in the tobacco filling portion 41, but between 200 mg/rod portion and 800 mg/rod portion may be cited, and between 250 mg/rod portion and 600 mg/rod portion is preferred. This range is particularly suitable if the tobacco filling portion 41 has a circumference of 22 mm and a length of 20 mm.

Various types of tobacco used can be used for the tobacco leaves used in the production of the shredded tobacco and the homogenized sheet. Examples that may be cited include yellow, Burley, orient, or native type, and other Nicotiana tabacum and Nicotiana rustica varieties, and mixtures thereof. A suitable blend of the abovementioned varieties may be used in a mixture to achieve the intended taste. Details on tobacco varieties are disclosed in “Dictionary of Tobacco, Tobacco Academic Studies Center, Mar. 31, 2009”. There are multiple conventional methods for producing the homogenized sheet, that is, methods for grinding tobacco leaves and processing them into a homogenized sheet. According to a first method, a paper sheet is produced by using a papermaking process. According to a second method, a suitable solvent such as water is mixed with ground tobacco leaves and homogenized, after which the homogenized material is thinly cast on a metal plate or a metal plate belt and dried, to produce a cast sheet. According to a third method, a suitable solvent such as water is mixed with ground tobacco leaves and homogenized, and the homogenized material is extruded into the form of a sheet and shaped to produce a calendered sheet. Details on types of homogenized sheets are disclosed in “Dictionary of Tobacco, Tobacco Academic Studies Center, Mar. 31, 2009”.

The amount of moisture contained in the tobacco filling material may be cited as 10 wt %-15 wt %, and preferably 11 wt %-13 wt % with respect to the total weight of the tobacco filling material. A moisture content such as this suppresses formation of wrapping stains and improves rolling suitability when the tobacco filling portion 41 is produced. There is no particular restriction on the size or method of preparation of the shredded tobacco contained in the tobacco filling material. For example, a material obtained by shredding dried tobacco leaves to a width of 0.5 mm or more and 2.0 mm or less may be used. Furthermore, when ground material is used in the homogenized sheet, a sheet may be formed by grinding dried tobacco leaves to an average particle size of approximately 20 μm to 200 μm and then homogenizing the ground tobacco, and the homogenized sheet may be shredded to a width of 0.5 mm or more and 2.0 mm or less for use.

The tobacco filling material comprises an aerosol base material for generating aerosol smoke. There is no particular restriction on the type of aerosol base material, and extracts from various types of natural products and/or components thereof may be selected in accordance with the application. Aerosol base materials which may be cited include water, glycerol, propylene glycol, triacetin, 1,3-butanediol, and mixtures thereof. There is no particular limitation as to the amount of the aerosol base material contained in the tobacco filling portion 41, and the amount is normally 5 wt % or greater and preferably 10 wt % or greater, and normally 50 wt % or less, and preferably 15 wt % or greater and 25 wt % or less, with respect to the total amount of tobacco filling material, from the point of view of sufficient aerosol generation and imparting a good flavor. In one example, the tobacco stick 40 is a liquid cartridge including a tobacco filling material comprising a liquid.

The tobacco filling material may contain a flavoring material. There is no particular limitation as to the type of flavoring material, and, from the point of view of imparting a pleasant flavor, there may be cited: acetanisole, acetophenone, acetylpyrazine, 2-acetylthiazole, alfalfa extract, amyl alcohol, amyl butyrate, trans-anethole, star anise oil, apple juice, Peru Balsam oil, beeswax absolute, benzaldehyde, benzoin resinoid, benzyl alcohol, benzyl benzoate, benzyl phenylacetate, benzyl propionate, 2,3-butanedione, 2-butanol, butyl butyrate, butyric acid, caramel, cardamom oil, carob absolute, β-carotene, carrot juice, L-carvone, β-caryophyllene, cassia bark oil, cedar wood oil, celery seed oil, chamomile oil, cinnamaldehyde, cinnamic acid, cinnamyl alcohol, cinnamyl cinnamate, citronella oil, DL-citronellol, clary sage extract, cocoa, coffee, cognac oil, coriander oil, cuminaldehyde, davana oil, 8-decalactone, γ-decalactone, decanoic acid, dill herb oil, 3,4-dimethyl-1,2-cyclopentanedione, 4,5-dimethyl-3-hydroxy-2,5-dihydrofuran-2-one, 3,7-dimethyl-6-octenoic acid, 2,3-dimethylpyrazine, 2,5-dimethylpyrazine, 2,6-dimethylpyrazine, 2-ethyl methylbutyrate, ethyl acetate, ethyl butyrate, ethyl hexanoate, ethyl isovalerate, ethyl lactate, ethyl laurate, ethyl levulinate, ethyl maltol, ethyl octanoate, ethyl oleate, ethyl palmitate, ethyl phenylacetate, ethyl propionate, ethyl stearate, ethyl valerate, ethyl vanillin, ethyl vanillin glucoside, 2-ethyl-3,(5 or 6)-dimethylpyrazine, 5-ethyl-3-hydroxy-4-methyl-2(5H)-furanone, 2-ethyl-3-methylpyrazine, eucalyptol, fenugreek absolute, genet absolute, gentian root infusion, geraniol, geranyl acetate, grape juice, guaiacol, guava extract, γ-heptalactone, γ-hexalactone, hexanoic acid, cis-3-hexen-1-ol, hexyl acetate, hexyl alcohol, hexyl phenylacetate, honey, 4-hydroxy-3-pentenoic acid lactone, 4-hydroxy-4-(3-hydroxy-1-butenyl)-3,5,5-trimethyl-2-cyclohexen-1-one, 4-(para-hydroxyphenyl)-2-butanone, 4-hydroxyundecanoic acid sodium, immortelle absolute, β-ionone, isoamyl acetate, isoamyl butyrate, isoamyl phenylacetate, isobutyl acetate, isobutyl phenylacetate, jasmine absolute, kola nut tincture, labdanum oil, lemon terpeneless oil, glycyrrhiza extract, linalool, linalyl acetate, lovage root oil, maltol, maple syrup, menthol, menthone, acetic acid L-menthyl, paramethoxybenzaldehyde, methyl-2-pyrrolyl ketone, methyl anthranilate, methyl phenylacetate, methyl salicylate, 4′-methylacetophenone, methylcyclopentenolone, 3-methylvaleric acid, mimosa absolute, molasses, myristic acid, nerol, nerolidol, γ-nonalactone, nutmeg oil, 8-octalactone, octanal, octanoic acid, orange flower oil, orange oil, orris root oil, palmitic acid, δ-pentadecalactone, peppermint oil, petitgrain Paraguay oil, phenethyl alcohol, phenethyl phenylacetate, phenylacetic acid, piperonal, plum extract, propenyl guaethol, propyl acetate, 3-propylidene phthalide, prune juice, pyruvic acid, raisin extract, rose oil, rum, sage oil, sandalwood oil, spearmint oil, styrax absolute, marigold oil, tea distillate, α-terpineol, terpinyl acetate, 5,6,7,8-tetrahydroquinoxaline, 1,5,5,9-tetramethyl-13-oxacyclo(8.3.0.0(4.9))tridecane, 2,3,5,6-tetramethylpyrazine, thyme oil, tomato extract, 2-tridecanone, triethyl citrate, 4-(2,6,6-trimethyl-1-cyclohexenyl)-2-buten-4-one, 2,6,6-trimethyl-2-cyclohexen-1,4-dione, 4-(2,6,6-trimethyl-1,3-cyclohexadienyl)-2-buten-4-one, 2,3,5-trimethylpyrazine, γ-undecalactone, γ-valerolactone, vanilla extract, vanillin, veratraldehyde, violet leaf absolute, N-ethyl-p-menthane-3-carboamide (WS-3), and ethyl-2-(p-menthane-3-carboxamide) acetate (WS-5), with menthol being especially preferred. One of these flavoring materials may be used alone, or two or more may be used in combination.

There is no particular limitation as to the amount of flavoring contained in the tobacco filling material, and, from the point of view of imparting a good flavor, the content is normally 10,000 ppm or greater, preferably 20,000 ppm or greater, and more preferably 25,000 ppm or greater, and is normally 70,000 ppm or less, preferably 50,000 ppm or less, more preferably 40,000 ppm or less, and even more preferably 33,000 ppm or less.

The inhaler 10 comprises a case 11 in which various components to be described below are mounted. The case 11 is provided with: an accommodating portion 12 capable of accommodating at least a portion of the tobacco stick 40 which has been inserted from an opening portion 12a of the accommodating portion 12; a guide portion 13 for guiding insertion of the tobacco stick 40 from the opening portion 12a of the accommodating portion 12; an air flow path 14 which communicates with the accommodating portion 12 and allows air to be introduced into the accommodating portion 12; and a microwave shield 15 for preventing external leakage of microwaves supplied to the accommodating portion 12. An inner surface of the microwave shield 15 may be configured by a metal plate or a metal mesh, etc. in order to confine microwaves to the inside of the accommodating portion 12. The air flow path 14 has an air intake port 14a provided on the exterior of the case 11, and is provided so as to introduce air into the accommodating portion 12 from the air intake port 14a. The air flow path 14 may be provided with a microwave shield 14b which allows the air to pass while blocking microwaves. The air flow path 14 is not limited to being provided on the side face of the accommodating portion 12 as shown in FIG. 1, and it may equally be provided on a bottom face or an upper face of the accommodating portion 12.

Furthermore, the aerosol-generating device 10 also comprises: a wireless transmitter 20, a transmission antenna 21, a transmission waveguide 22, a wireless receiver 23, a reception antenna 24, a reception waveguide 25, a control unit 30, a power source unit 31, a notification unit 32, a communication unit 33, an object detector 34, and a mouthpiece detector 35. These components 20-25 and 30-34 are mounted inside the case 11.

The wireless transmitter 20 is an example of an electromagnetic wave oscillation device which comprises a semiconductor (solid-state) oscillator and generates high-frequency electromagnetic waves having a predetermined frequency. The semiconductor oscillator is configured by a semiconductor element such as, for example, an LDMOS transistor, a GaAs FET, an SiC MESFET, or a GaN HFET. High-frequency electromagnetic waves mean high-frequency electromagnetic waves of between 3 Hz and 3 THz. Microwaves mean high-frequency electromagnetic waves of between 300 MHz and 300 GHz. The wireless transmitter 20 is described below as an element for generating microwaves, but this is not limiting provided that it is configured to generate desired electromagnetic waves. The wireless transmitter 20 is capable of generating microwaves having a frequency (e.g., 2.40-2.50 GHz) suitable for heating the tobacco stick 40 (aerosol source). In this embodiment, the wireless transmitter 20 generates microwaves with a frequency of 2.45 GHz. Furthermore, the wireless transmitter 20 may comprise an amplifier for amplifying a high-frequency electromagnetic field. In the wireless transmitter 20, the semiconductor oscillator itself may have the function of an amplifier, or else an amplifier configured as an electronic component separate to the semiconductor oscillator may be provided. In one example, the wireless transmitter 20 outputs ISM (Industrial, Scientific and Medical) band microwaves. In one example, the wireless transmitter 20 may output microwaves at 2.4 GHz-2.5 GHz (2.45 GHz band), 5.725 GHz-5.875GHz (5.8 GHz band), and 24 GHz-24.25 GHZ (24.125 GHz band). The frequency and bandwidth of the microwaves output by the wireless transmitter 20 are controlled by the control unit 30, and signals including multiple frequency bands, such as the 2.45 GHz band and the 5.8 GHz band, may be generated, for example. Furthermore, the strength of signals output by the wireless transmitter 20 is also controlled by the control unit 30.

It should be noted that the device for generating the high-frequency electromagnetic field may also be a magnetron oscillator, but using a semiconductor oscillator as the wireless transmitter 20 allows for a more compact body as compared to when a magnetron oscillator is used. Furthermore, a semiconductor oscillator can operate at a lower voltage than a magnetron oscillator, therefore enabling better frequency stability and output stability. However, the wireless transmitter 20 of this embodiment only needs to be capable of generating a high-frequency electromagnetic field of a predetermined frequency, and may therefore also be a magnetron oscillator.

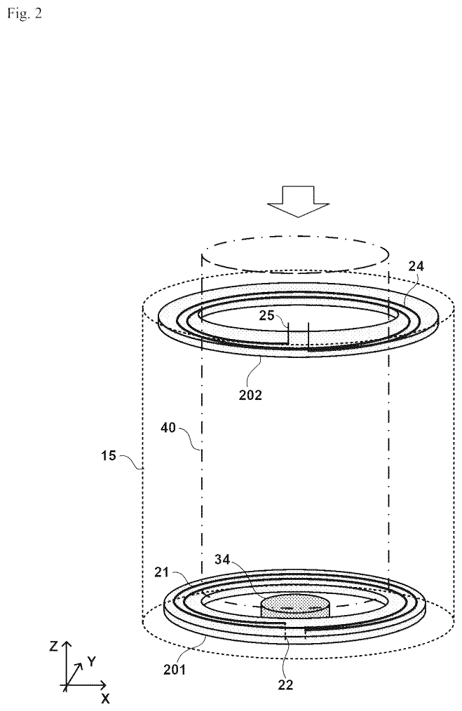

The microwaves generated by the wireless transmitter 20 are guided to the transmission antenna 21 through the transmission waveguide 22. The transmission waveguide 22 connects the wireless transmitter 20 and the transmission antenna 21, and guides the microwaves generated by the wireless transmitter 20 to the transmission antenna 21 in order to heat the tobacco stick 40 (aerosol source). The microwaves received by the reception antenna 24 are propagated to the wireless receiver 23 through the reception waveguide 25 connecting the wireless receiver 23 and the reception antenna 24. A waveguide tube or a coaxial cable, etc. may be used as the transmission waveguide 22 and the reception waveguide 25, for example. The transmission waveguide 22 may be omitted when the wireless transmitter 20 and the transmission antenna 21 are directly connected, and the reception waveguide 25 may be omitted when the wireless receiver 23 and the reception antenna 24 are directly connected. The transmission antenna 21 functions as a supply unit for delivering (emitting), into the accommodating portion 12, the microwaves guided through the transmission waveguide 22. The reception antenna 24 functions as a receiver for conducting, to the reception waveguide 25, the microwaves propagated inside the accommodating portion 12. In the example of FIG. 1, the transmission antenna 21 and the reception antenna 24 are provided on the bottom face and upper face of the accommodating portion 12, but this is not limiting, and they may equally be provided on a side face, as will be described later. In one example, the transmission antenna 21 and the reception antenna 24 are arranged at positions sandwiching the tobacco stick 40 which is disposed inside the accommodating portion 12. The detailed configuration of the transmission antenna 21 will be described later with reference to FIG. 2-9.

The wireless receiver 23 comprises an analog-digital converter (ADC) and converts input microwaves to digital electrical signals. The wireless receiver 23 comprises a local oscillator which performs homodyne detection and heterodyne detection and will be assumed to demodulate the microwave signals, but in one example, the microwave signals may be demodulated by using high-frequency output from an oscillator shared with the wireless transmitter 20. Furthermore, the wireless receiver 23 acquires the received signal strength of detected electromagnetic waves and sends information indicating the received signal strength to the control unit 30.

Moreover, in order to protect the wireless transmitter 20, the transmission waveguide 22 may be provided with an isolator for absorbing reflected waves returned toward the wireless transmitter 20 via the transmission antenna 21, and an impedance matching unit. Furthermore, the transmission waveguide 22 may be provided with a power monitor for detecting the power of incident waves from the wireless transmitter 20 and the power of reflected waves from the tobacco stick 40 and/or an impedance matching unit for matching impedances of the transmission antenna 21 and the tobacco stick 40 to reduce the power of reflected waves. Furthermore, the reception waveguide 25 may likewise also be provided with a power monitor for detecting the power of microwaves input to the wireless receiver 23 and/or an impedance matching unit for matching impedances of the reception antenna 24 and the tobacco stick 40 to increase reception efficiency of the reception antenna 24. It should be noted that the isolator, the impedance matching units and the power monitors may also be provided in a wireless circuit of the wireless transmitter 20 or the wireless receiver 23.

The control unit 30 comprises a processor and a memory, functions as an arithmetic processing device and a control device, and controls overall operation of the inhaler 10 in accordance with various programs. Specifically, the control unit 30 may control the wireless transmitter 20 to deliver microwaves from the transmission antenna 21 in accordance with a user atomization request, and thereby heat the tobacco stick 40. Furthermore, the control unit 30 may control the wireless transmitter 20 so that the tobacco stick 40 is heated in accordance with a desired preset heating profile. The control unit 30 controls overall operation of the aerosol-generating device 10 by means of the processor which executes programs stored in a memory, the processor being realized, for example, by a CPU (central processing unit) or an electronic circuit such as a microprocessor.

The power source unit 31 supplies power to the wireless transmitter 20 based on control afforded by the control unit 30. The power source unit 31 is configured by a rechargeable battery such as a lithium ion secondary battery, for example. Providing a power source unit 31 such as this enables the inhaler 10 to be portable.

The notification unit 32 notifies the user of information based on control afforded by the control unit 30. Information notified to the user which may be cited includes, for example: information indicating detection of insertion of the tobacco stick 40 into the accommodating portion 12; information indicating the start of microwave heating of the tobacco stick 40; information indicating a transition to an aerosol inhalation-possible state; error information; and remaining capacity information of the power source unit 31 (battery remaining capacity information), etc. The notification unit 32 may be configured by a light-emitting element such as an LED (light-emitting diode), a vibrating element such as a vibration motor, or a sound output element. The notification unit 32 may be configured by display element (display) such as an LCD (liquid crystal display). The notification unit 32 may be a combination of two or more elements among a light-emitting element, a vibrating element, a sound output element, and a display element.

The communication unit 33 is an interface for acquiring information relating to a state of use of the inhaler 10 and sending this information to an external data server or a user mobile terminal device, etc. (referred to below as a data server, etc.), and for receiving data from the data server, etc. The communication unit 33 can communicate with the data server, etc., via short-range wireless communication such as Bluetooth (registered trademark) or long-range wireless communication such as LPWA (low power wide area). Note that communication between the communication unit 33 and the data server, etc., is not limited to the wireless communication mentioned above and may equally be another form of wireless communication or else wired communication.

The object detector 34 detects whether or not the tobacco stick 40 is inside the accommodating portion 12. By this means, the control unit 30 is able to determine whether or not there is a state in which the tobacco stick 40 is accommodated (inserted) inside the accommodating portion 12, based on a detection result from the object detector 34, and can control microwave delivery from the transmission antenna 21 in accordance with the result of this determination. For example, when the control unit 30 has determined a state in which the tobacco stick 40 is not accommodated inside the accommodating portion 12, based on the detection result from the object detector 34, the control unit 30 prohibits microwave delivery from the transmission antenna 21. Meanwhile, when the control unit 30 has determined a state in which the tobacco stick 40 is accommodated (inserted) inside the accommodating portion 12, based on the detection result from the object detector 34, the control unit 30 enables microwave delivery from the transmission antenna 21. The object detector 34 may be configured by a capacitive proximity sensor, but this is not limiting, and it may equally be configured by a contact sensor (e.g., a pressure sensor) or a photoelectric sensor, etc. It should be noted that in the example of FIG. 1, the object detector 34 is provided on the bottom face (the inner face on the-Z direction side) of the accommodating portion 12, but may equally be provided on the side face or upper face of the accommodating portion 12, or on the guide portion 13.

Moreover, FIG. 1 shows only one object detector 34 being provided, but two or more object detectors may equally be provided. Furthermore, the object detector 34 may detect the type of tobacco stick 40, in addition to the presence or absence of the tobacco stick 40. For example, if the object detector 34 comprises two electrodes, then it may detect the type of tobacco stick 40 or conditions such as electrical characteristics of the tobacco stick 40 by applying a voltage while in a state of contact with the tobacco stick 40 and detecting a state of conduction such as the amount of current flowing between the electrodes. For example, in order for the tobacco stick 40 to be detected by the object detector 34, a circuit element such as a predetermined resistance element may be provided, and the type of tobacco stick 40 may then be identified based on the electrical resistance value detected by the object detector 34.

Furthermore, the mouthpiece 50, which the user holds in their mouth in order to draw in vapor (aerosol-containing vapor) from the accommodating portion 12, may be attached to the inhaler 10 of this embodiment, as shown in FIG. 1. The mouthpiece 50 may be attached to the guide portion 13 of the inhaler 10 so as to cover a part (mouthpiece portion 42) of the tobacco stick 40 protruding from the inhaler 10 (accommodating portion 12). The mouthpiece 50 is then provided with a microwave shield 51 for blocking leakage of microwaves to the outside from the accommodating portion 12 through the opening portion 12a and the guide portion 13. The microwave shield 51 may be configured by a metal mesh or a metal plate, etc. having an opening, so that vapor is allowed to pass while microwaves are blocked. The sizes of holes and openings in metal meshes of the microwave shields 15, 51, 14b are set at no greater than ½ of the wavelength of the microwaves output by the wireless transmitter 20 in one example, and are set at no greater than ¼ of the wavelength, no greater than 1/10 of the wavelength, or no greater than 1/20 of the wavelength, for example.

When the mouthpiece 50 comprising the microwave shield 51 is used, the inhaler 10 may be provided with the mouthpiece detector 35 for detecting whether or not the mouthpiece 50 is attached. This allows the control unit 30 to control delivery of microwaves from the transmission antenna 21 on the basis of a detection result from the mouthpiece detector 35. For example, when the control unit 30 has determined that the mouthpiece 50 is not attached, based on the detection result from the mouthpiece detector 35, the control unit 30 prohibits microwave delivery from the transmission antenna 21. Meanwhile, when the control unit 30 has determined that the mouthpiece 50 is attached, based on the detection result from the mouthpiece detector 35, the control unit 30 enables microwave delivery from the transmission antenna 21. Note that the inhaler 10 may be configured so that the user holds the mouthpiece portion 42 of the tobacco stick 40 directly in their mouth, without the use of the mouthpiece 50. In this case, a microwave shield which is configured by a metal mesh or a metal plate, etc. having an opening in order to block microwaves may be provided on the mouthpiece portion 42 of the tobacco stick 40.

The configurations of the transmission antenna 21 and the reception antenna 24 will be described next with reference to FIG. 2. The transmission antenna 21 and reception antenna 24 according to this embodiment are loop antennas. Note that, in FIG. 2, the transmission antenna 21 and the reception antenna 24 are depicted as loop antennas having two turns, but they may equally have one turn or three or more turns. The transmission antenna 21 and the reception antenna 24 are arranged on dielectric bodies 201, 202 arranged on the microwave shield 15 accommodating the accommodating portion 12. This makes it possible to prevent short-circuiting between the microwave shield 15 and the transmission antenna 21 and reception antenna 24. Furthermore, the transmission antenna 21 and the reception antenna 24 are arranged on planes parallel to an XY plane. By this means, the transmission antenna 21 is electric-field coupled to the reception antenna 24, and electric field energy or magnetic field energy can be sent and received through a space containing the tobacco stick 40, thereby enabling heating of the tobacco stick 40.

It should be noted that, in the example of FIG. 2, the transmission antenna 21 and the reception antenna 24 are illustrated as being spider-shaped, with windings being wound on the same plane. However, the transmission antenna 21 and the reception antenna 24 may also have a coil shape which is wound along a cylinder whereof the axial direction is the direction in which the tobacco stick 40 is inserted. Furthermore, the transmission antenna 21 and the reception antenna 24 or the transmission waveguide 22 and the reception waveguide 25 may comprise an element such as a capacitor or an inductor for impedance matching.

Furthermore, in the example of FIG. 2, the transmission antenna 21 and the reception antenna 24 are described as being arranged on the dielectric bodies 201, 202, but a film may be formed on the transmission antenna 21 in order to prevent electrical short-circuiting, in which case the dielectric bodies 201, 202 may be omitted. In one example, the transmission antenna 21 and the reception antenna 24 may be arranged inside the dielectric bodies 201, 202. In one example, the dielectric bodies 201, 202 are formed from at least any of glass, or a synthetic resin such as an epoxy resin, a phenolic resin, or polyethylene, these materials functioning as fixing members for fixing the transmission antenna 21 and the reception antenna 24.

### Variant Example 1

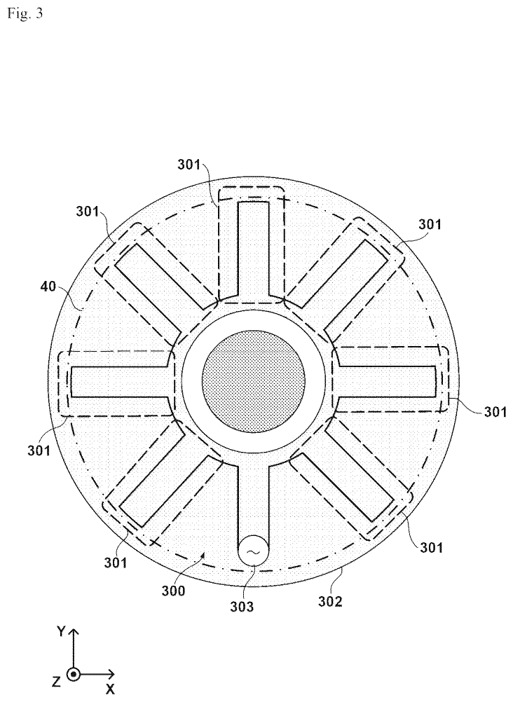

FIG. 3 illustrates Variant Example 1 of the transmission antenna 21 and the reception antenna 24. An antenna 300 shown in FIG. 3 may be applied to at least either of the transmission antenna 21 and the reception antenna 24. The antenna 300 has a switchback structure (meandering structure) 301, which can thereby achieve the length of the electrical pathway in a small space. Furthermore, the antenna 300 is arranged on a dielectric body 302, is connected to a waveguide by an electrical supply point 303, and sends or receives microwaves. Note that the antenna 300 is depicted as a loop antenna with one turn, but it may equally have two or more turns. Furthermore, the meandering structure 301 of the antenna 300 is depicted as switching back within the XY plane, but the structure may equally switch back in the Z direction.

### Variant Example 2

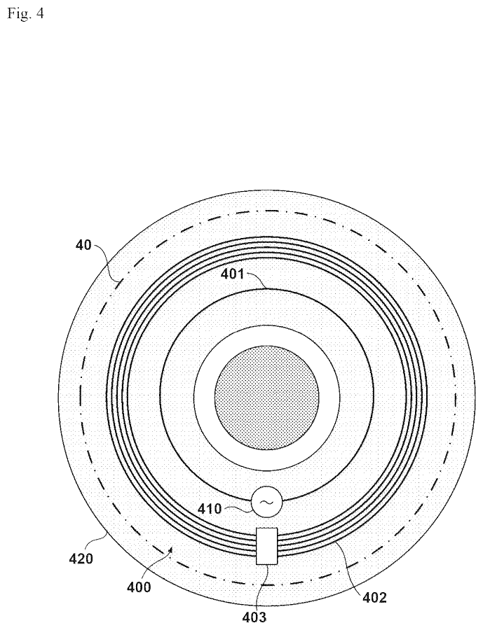

FIG. 4 illustrates Variant Example 2 of the transmission antenna 21 and the reception antenna 24. An antenna 400 shown in FIG. 4 may be applied to at least either of the transmission antenna 21 and the reception antenna 24. The antenna 400 is arranged on a dielectric body 420 and comprises: a main loop 401 connected to a waveguide 410 via a conductor, and a parasitic loop 402 which is not connected to the waveguide 410 via a conductor. The transmission waveguide 22 and the reception waveguide 25 may correspond to the waveguide 410. A tuning circuit 403 capable of variably adjusting the impedance is connected to the parasitic loop 402. This enables the impedance of the tuning circuit 403 to be matched when there is a change in the frequency of microwaves output by the transmitter 20. It should be noted that the example of FIG. 4 depicts the main loop 401 with one turn and the parasitic loop 402 with five turns, but different numbers of turns may be applied. Moreover, in one example, the tuning circuit 403 need not be connected to the parasitic loop 402. In this case, the parasitic loop 402 should be a parasitic element and it need not have the shape of the loop.

### Variant Example 3

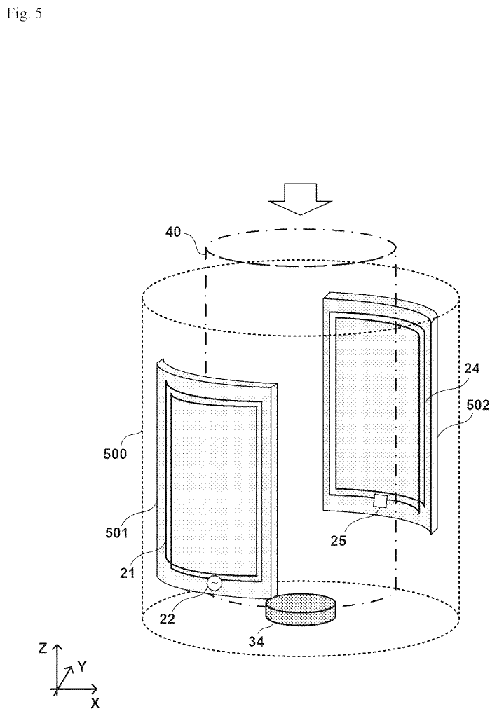

Variant Example 3 of the transmission antenna 21 and the reception antenna 24 will be described with reference to FIG. 5. The transmission antenna 21 and the reception antenna 24 according to this embodiment are arranged on a circumferential surface having the direction of insertion of the tobacco step 40 as the axial direction. Note that the same reference signs are used for components, functions and processing which are the same as in the first embodiment, and a further description will be omitted.

The microwave shield 15 surrounding the accommodating portion 12 of the inhaler 10 shown in FIG. 5 comprises a cylindrical portion 500. The cylindrical portion 500 comprises dielectric bodies 501, 502, the transmission antenna 21 is arranged on the dielectric body 501, and the reception antenna 24 is arranged on the dielectric body 502. Moreover, the transmission antenna 21 and the reception antenna 24 may be arranged on the same dielectric body.

By arranging the transmission antenna 21 and the reception antenna 24 on the circumferential surface of the cylindrical portion 500 in this way, there is a greater degree of freedom in the antenna arrangement.

### Variant Example 4

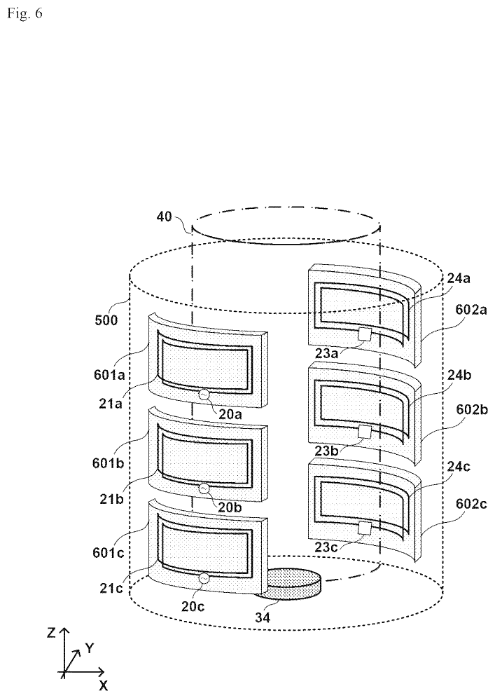

Variant Example 4 of the transmission antenna 21 and the reception antenna 24 will be described with reference to FIG. 6. The inhaler 10 according to this embodiment comprises a plurality of transmission antennas 21a-21c (also referred to collectively below as the transmission antenna 21), and a plurality of reception antennas 24a-24c (also referred to collectively below as the reception antenna 24). Note that the same reference signs are used for components, functions and processing which are the same as in the first embodiment, and a further description will be omitted.

The inhaler 10 according to this embodiment comprises wireless transmitters 20a-20c (also referred to collectively below as the wireless transmitter 20) for each of the plurality of transmission antennas 21a-21c (also referred to collectively below as the transmission antenna 21). The transmission antennas 21a-21c are respectively arranged on dielectric bodies 601a-601c (also referred to collectively below as the dielectric body 601) which are arranged on the cylindrical portion 500 of the microwave shield 15. Moreover, the plurality of transmission antennas 21 may also be arranged on one dielectric body 601. Furthermore, wireless receivers 23a-23c (also referred to collectively below as the wireless receiver 23) are provided for each of the plurality of reception antennas 24a-24c (also referred to collectively below as the reception antenna 24). The reception antennas 24a-24c are respectively arranged on dielectric bodies 602a-602c (also referred to collectively below as the dielectric body 602) which are arranged on the cylindrical portion 500 of the microwave shield 15. Moreover, the plurality of reception antennas 24 may also be arranged on one dielectric body 602. The control unit 30 may heat different parts of the tobacco stick 40 by controlling a transmission timing of the wireless transmitter 20. Furthermore, the control unit 30 according to this embodiment controls the wireless receiver 23 and adjusts the impedance, thereby performing control so that microwaves are received from a specific reception antenna 24. This makes it possible to measure the impedance, including the impedance of the space containing the tobacco stick 40 between a specific transmission antenna 21 and reception antenna 24, and it is possible to measure the state of different parts of the tobacco stick 40.

It should be noted that the example of FIG. 6 shows the transmission antennas 21a-21c being controlled by individual wireless transmitters 20, but one wireless transmitter 20 may equally control the plurality of transmission antennas 21. Alternatively, the microwaves may be distributed by a branch circuit so that the microwaves output from one wireless transmitter 20 are supplied to the accommodating portion 12 from the plurality of transmission antennas 21. Similarly, one wireless receiver 23 may be connected to the plurality of reception antennas 24, and control may be performed individually or collectively so that microwaves are received from the plurality of reception antennas 24.

Furthermore, the example of FIG. 6 shows the plurality of transmission antennas 21 and the plurality of reception antennas 24 with the same dimensions, but antennas having different resonant frequencies designed for different frequency bands may also be combined. This enables microwaves to be delivered from a suitable antenna according to the frequency band of the microwaves output from the wireless transmitter 20.

Furthermore, the example of FIG. 6 shows all of the plurality of transmission antennas 21 aligned in the Z direction. In one example, the plurality of transmission antennas 21 may be aligned in a circumferential surface direction of the cylindrical portion of the accommodating portion 12.

### Variant Example 5

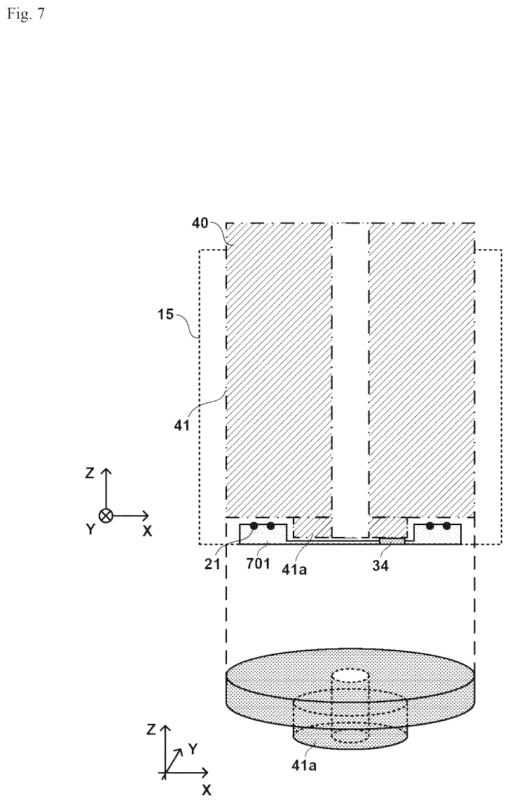

Variant Example 5 of the transmission antenna 21 and the reception antenna 24 will be described with reference to FIG. 7. The transmission antenna 21 according to this embodiment engages with the tobacco stick 40.

The tobacco stick 40 comprises, at a lower portion of the tobacco filling portion 41, an engaging portion 41a for engagement with the transmission antenna 21. Furthermore, the transmission antenna 21 or a dielectric body 701 on which the transmission antenna 21 is arranged comprises a recess having a larger diameter than the outer diameter of the engaging portion 41a. The outer diameter of the engaging portion 41a is smaller than the inner diameter of the transmission antenna 21. This allows the engaging portion 41a to advance to the same position as the transmission antenna 21 as seen in the Z direction. In this way, the transmission antenna 21 can function as a guide member for positioning the tobacco stick 40. Moreover, the engaging portion 41a may or may not be filled with tobacco.

Furthermore, the engaging portion 41a has a cylindrical shape. Furthermore, the partial section of the tobacco stick 40 connected to the engaging portion 41a also has a cylindrical shape. This also allows the engaging portion 41a to function as an air flow path.

### Variant Example 6

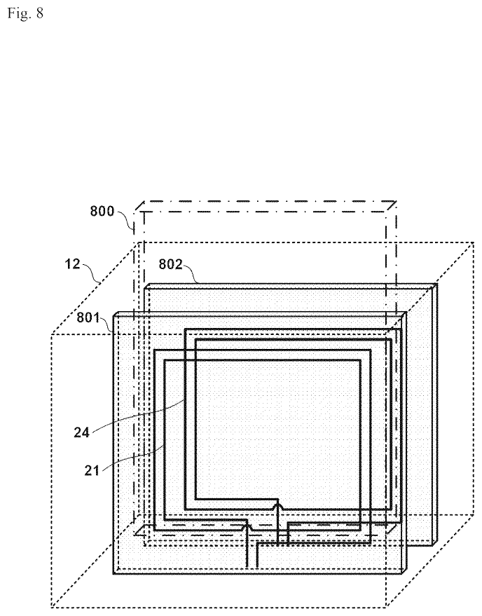

Variant Example 6 of the transmission antenna 21 and the reception antenna 24 will be described with reference to FIG. 8. A board-shaped tobacco plate 800 is inserted into the inhaler 10 according to this embodiment. Furthermore, the accommodating portion 12 also has a prismatic shape rather than a cylindrical shape to allow the tobacco plate 800 to be inserted.

Furthermore, the transmission antenna 21 and the reception antenna 24 according to this embodiment are arranged on dielectric bodies 801, 802 arranged so that the tobacco plate 800 is sandwiched therebetween, as shown in FIG. 8. Furthermore, the transmission antenna 21 and the reception antenna 24 have a square loop shape. This enables the corner parts of the tobacco plate 800 to be efficiently heated. Note that FIG. 8 is an example, and at least either of the transmission antenna 21 and the reception antenna 24 may have a circular loop shape.

### Variant Example 7

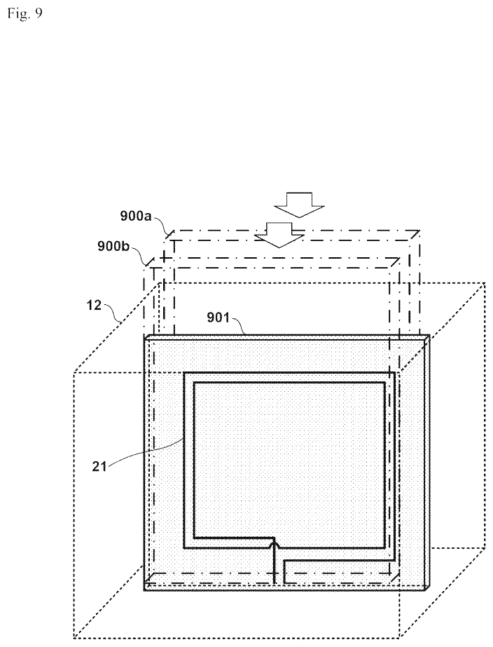

Variant Example 7 of the transmission antenna 21 and the reception antenna 24 will be described with reference to FIG. 9. Board-shaped tobacco plates 900a, 900b are inserted into the inhaler 10 according to this embodiment, in the same way as in Variant Example 6. Furthermore, the accommodating portion 12 also has a prismatic shape rather than a cylindrical shape to allow the tobacco plates 900a, 900b to be inserted.

Furthermore, the transmission antenna 21 according to this variant example is arranged on a dielectric body 901 arranged at a position sandwiched between the tobacco plates 900a, 900b, as shown in FIG. 9. This enables microwaves output from the transmission antenna 21 to be efficiently absorbed by the plurality of tobacco plates 900a, 900b.

### Other Embodiments

It should be noted that the embodiments above described the inhaler 10 comprising the transmission antenna 21 and the reception antenna 24, but the wireless receiver 23, the reception antenna 24, and the reception waveguide 25 may be omitted when microwaves are output from the transmission antenna 21 in a fixed pattern or a pattern designated by the user, that is, when the control unit 30 does not control the wireless transmitter 20 in accordance with the state of reception of microwaves by the reception antenna 24.

Furthermore, the variant examples of the embodiments described above may be combined in any way. For example, a second transmission antenna may be arranged on the side face of the accommodating portion 12, as described in Variant Example 3, while a first transmission antenna is arranged on the bottom face of the accommodating portion 12, as described in Variant Example 1. This enables microwaves to be suitably supplied to the tobacco stick 40 in accordance with the shape of the accommodating portion 12.

The invention is not limited to the embodiments described above and may be modified or altered in various ways within the scope of the essential point of the invention.

1. An aerosol-generating device comprising:
an accommodating portion capable of accommodating at least a portion of an aerosol-generating article containing an aerosol source;
an oscillation unit configured to oscillate electromagnetic waves;
a first loop antenna for supplying the electromagnetic waves oscillated by the oscillation unit to the accommodating portion; and
a control unit configured to control the oscillation unit.

2. The aerosol-generating device as claimed in claim 1, wherein the aerosol-generating article has a cylindrical part, and an inner diameter of the first loop antenna is greater than an inner diameter of the cylindrical part.

3. The aerosol-generating device as claimed in claim 1, wherein the aerosol-generating article has an engaging structure for engagement with the first loop antenna.

4. The aerosol-generating device as claimed in claim 1, wherein the aerosol-generating article has a board-shaped part in which the aerosol source is accommodated, and the first loop antenna is arranged within a plane parallel to the board-shaped part of the aerosol-generating article and facing the board-shaped part.

5. The aerosol-generating device as claimed in claim 4, wherein the aerosol-generating article comprises a first board-shaped part and a second board-shaped part arranged so as to sandwich the first loop antenna, the aerosol source being accommodated in the first board-shaped part and the second board-shaped part.

6. The aerosol-generating device as claimed in claim 1, further comprising a second loop antenna for receiving the electromagnetic waves emitted from the first loop antenna, wherein the control unit controls the oscillation unit in accordance with a state of reception of the electromagnetic waves received by the second loop antenna.

7. The aerosol-generating device as claimed in claim 1, further comprising a third loop antenna for supplying the electromagnetic waves oscillated by the oscillation unit into the accommodating portion.

8. The aerosol-generating device as claimed in claim 7, wherein the aerosol-generating article comprises a columnar part in which the aerosol source is accommodated, and
the first loop antenna and the third loop antenna are arranged at different positions in an axial direction of the columnar part.

9. The aerosol-generating device as claimed in claim 7, wherein a resonant frequency of the first loop antenna and a resonant frequency of the third loop antenna are different.

10. The aerosol-generating device as claimed in claim 1, wherein the loop antenna has a meandering structure.

11. The aerosol-generating device as claimed in claim 1, wherein the loop antenna has two or more turns.

12. The aerosol-generating device as claimed in claim 1, wherein the aerosol-generating article has a columnar part in which the aerosol source is accommodated, and the loop antenna is arranged within a plane parallel to a bottom face of the columnar part.

13. The aerosol-generating device as claimed in claim 12, wherein the aerosol-generating article has a columnar part in which the aerosol source is accommodated, and the loop antenna is arranged laterally in relation to a direction of insertion of the aerosol-generating article.

14. The aerosol-generating device as claimed in claim 1, wherein the loop antenna is arranged on an electromagnetic wave shield of the accommodating portion, with a fixing member comprising a dielectric body interposed therebetween.
